(19) United States
(12) Patent Application Publication
(10) Pub. No.: US 2016/0042483 A1
(43) Pub. Date: Feb. 11, 2016

(54) UNIFIED PATIENT CONTROLLED MEDICAL RECORD SYSTEM

(71) Applicants: Alvin Quan Vo, San Jose, CA (US); Shahram S. Gholami, Monte Sereno, CA (US)

(72) Inventors: Alvin Quan Vo, San Jose, CA (US); Shahram S. Gholami, Monte Sereno, CA (US)

(21) Appl. No.: 14/451,514

(22) Filed: Aug. 5, 2014

(51) Int. Cl. G06Q 50/24; G06F 19/00

(52) U.S. Cl. CPC G06Q 50/24; G06F 19/322

(57) ABSTRACT

System and method for a patient controlled electronic (client-server) medical record system that can be used by patients, various healthcare professionals, and even emergency medical services. Patients set up the system, own and control the data, and authorize selected healthcare professionals to enter notes and other medical records (which may be imported from various legacy medical record systems) into the patient controlled system. The healthcare professionals can also retrieve data from the system according to various levels of patient authorization. Security is maintained using a combination of machine readable ID codes and patient PIN numbers, and emergency medical services personnel may also be granted at least lower level access to the system even without PIN codes, which is useful when patients are found in an unresponsive state. Other system functions, including automatic appointment scheduling, automated physician enrollment and referrals, and various messaging functions are also described.

### BACKGROUND OF THE INVENTION

1. Field of the Invention

This invention is in the field of electronic patient medical record systems

2. Description of the Related Art

Various types of electronic medical records (electronic health records) are ubiquitous in the medical industry. These legacy systems are generally intended for the benefit of healthcare workers (e.g. physicians), hospitals/clinics, health insurers and other reimbursement agencies. Although these legacy systems are designed to keep track of patient medical records, they usually do so on a relatively narrow, per-medical institution, basis.

There are a large number of different electronic medical records systems presently in use. Although there have been some attempts to create various standardized methods to enable different medical records systems to exchange data (e.g. ANSI X12, HL7, DICOM, openEHR and the like), each individual system generally functions in its own unique manner, and each system will generally have its own unique data access and retention policies. An additional problem is that because patients typically interact with a variety of different healthcare workers and healthcare institutions throughout their lives, an individual patent's medical data can become highly fragmented into different data silos, each data silo run by a different legacy electronic medical record system.

Many medical records contain images and other memory intensive data, and to reduce costs, medical institutions often end up placing patient medical data into difficult to access archives after unpredictable lengths of time. Some data can be lost altogether. Thus the present state of electronic medical records is not entirely satisfactory.

### BRIEF SUMMARY OF THE INVENTION

The invention is based, in part, on the insight that the problems of incompatible medical record systems, data fragmentation, data silos, and general lack of availability of older medical records can be addressed by providing a new type of patient controlled medical record system. In this patient controlled medical record system, the patient owns the data, and can control how long the data is stored (ideally for at least the lifetime of the patient). According to the invention, the patient can also (at least to some extent) control which healthcare practitioners are authorized to do functions such as accessing the database, uploading notes and records, retrieving specific notes and records, and the like.

The invention's patient controlled medical record database need not supplant legacy healthcare institution controlled medical databases. Indeed often it can be used as a supplement to legacy medical record databases. Physicians, for example, can continue to use their legacy systems as desired. However upon patient request, physicians can also transfer or port data from their legacy systems to the invention's patient controlled database. Once the data has been transferred or ported, the patient can insure that their healthcare data will always be available to other patient authorized healthcare professionals (HCP), regardless of the HCP's healthcare institution or choice of legacy system. The patient can also insure that the healthcare data will be available for as long as the patient has need of it, up to the patient's entire lifetime or even longer as authorized and financed.

The invention thus teaches a “unified” patient controlled medical record system that can be used by both patients and various healthcare professionals. As will be discussed, an additional advantage of this unified patient controlled system is that it also can be quite useful for emergency medical responder type HCP as well.

The invention will typically be implemented in the form of software running on at least one computer server, communicating (often via the Internet) with various computerized devices such as Internet connected Smartphones, tablet computers, personal computers, and the like. The computerized devices in turn will run software (e.g. web browsers, apps, and the like) configured to send and receive data from both the server(s) and the various users. The server software will generally be partitioned into at least two sides: a first higher level of authorization patient side, and a second lower level of authorization HCP side.

### BRIEF DESCRIPTION OF THE DRAWINGS

FIG. 1 shows the invention's unified patient-controlled client-server medical record system operating (over the Internet) with different client computerized devices operated by patients, healthcare professionals (HCP) such as physicians and laboratories, and emergency medical services. The patient gets highest level access by providing both a machine readable ID code (in this example a bar code affixed to a driver's license) and a PIN number. Some previously linked and patient authorized healthcare professionals may also get high level access via their own login and authentication methods. Emergency medical services can get immediate low level access to at least the patient's identification, emergency contact numbers, and critical medical information “e.g. I am a diabetic” by scanning just the patient's machine readable ID code. The invention can work in parallel with legacy, healthcare professional only, type medical record systems.

FIG. 2 shows a chart illustrating different levels of system access. Here if the system is only supplied with a machine readable ID codes (such as bar codes), then the system only provides low level access to the patient's records. However if the system is supplied with both the machine readable ID codes and at least one supplemental codes (e.g. a PIN code that the patient or patient's emergency contact knows), then the system provides higher level access to patient medical records.

FIG. 3 shows a chart showing some of the major features of the patient side of the unified patient-controlled client server medical record system.

FIG. 4 shows a chart showing some of the major features of the HCP (e.g. physician, other healthcare professional) side of the unified patient-controlled client server medical record system.

FIG. 5 shows how the patient can initialize and take control of the system by opening a new patient account.

FIG. 6 shows an example of a patient entered general profile.

FIG. 7 shows how the patient may control which physicians or other healthcare professionals to add to the patient's personal system by selecting from a list of potential healthcare professionals (here a list of local physicians). If the healthcare professional accepts the patient's invitation, then the healthcare professional is then linked with that patient's particular medical records account.

FIG. 8A shows how the patient may enter their particular medical history record into the system. Here patients may, for example, at least initially populate this account with data from their personal records.

FIG. 8B shows how the patient may also enter their particular surgical history into the system.

FIG. 9 shows how the patient may also enter in various medical documents (that the patient may have previously obtained from healthcare professionals in the past) into the system. Suitably authorized healthcare professionals can also add additional medical documents here as well.

FIG. 10 shows an access control configuration screen where the patient decides which healthcare professionals will be allowed access to a particular medical document. This is one way in which the patient maintains control of the system.

FIG. 11 shows how a patient may also make use of the system to request an appointment with a particular healthcare professional at a particular time and date. The healthcare professional is shown responding to this request in FIG. 18.

FIG. 12 shows the login screen of a healthcare professional (here a physician). This figure and the next series of figures show the healthcare professional side of the system in operation.

FIG. 13 shows how the healthcare professional can review their list of linked patients, and review profile data for specific patients.

FIG. 14 shows how the healthcare professional can review insurance data provided by a particular linked patient.

FIG. 15 shows how the healthcare professional, assuming that the patient has given them suitable access, can review various medical documents associated with a particular patient.

FIG. 16 shows how the healthcare professional can also add new medical documents or notes to that particular patient's medical record. In some embodiments, these documents may be obtained from a legacy medical record system and imported by cut and paste, file transfer, or various direct electronic transfer methods.

FIG. 17 shows how the healthcare professional may also use the system to automatically refer the patient to another healthcare professional.

FIG. 18 shows this healthcare professional responding to the patient request for an appointment (previously shown in FIG. 11). Here the healthcare professional needs to reschedule and is thus changing the appointment time slot.

FIG. 19 shows how the system can automatically notify the patient of the new appointment time (here by an email message to the patient's smartphone). Other notification methods, such as automated phone calls, SMS text messages, fax, or other notification methods may also be used.

FIG. 20 shows the system operating in an emergency medical responder mode. Here an emergency medical responder, upon finding an unresponsive patient, can scan the patient's machine readable ID code and get at least low level access to the system. This low level access may give emergency contact information and also warn about any major medical problems that the patient desires to reveal, such as diabetes. The emergency medical responder can then use the emergency contact information to obtain the patient's PIN code, and then get still higher level access to retrieve the data shown in FIG. 21.

FIG. 21 shows the system operating in emergency medical responder mode after receiving the PIN code from the patient's emergency medical contact. Here the patient's medical records are made available to the emergency medial responder (here formatted for quick and easy reading).

### DETAILED DESCRIPTION OF THE INVENTION

In some embodiments, the invention may be a computer system and method for providing and/or operating a unified medical record system that can to be used and operated by patients and healthcare professionals (e.g. physicians, physician's assistants, dentists, clinical laboratories, and the like) as well as by various emergency medical services. Here emergency medical services may be either considered to be a unique type of healthcare professional, or alternatively may be considered to constitute a different third class of users.

As previously discussed, among other differences between the present invention and various prior art computerized medical records systems, the present invention is designed to be patient controlled. According to the invention, the patient can enter data directly into the system, can control which healthcare professionals can access the data, and can control the lifetime of the patient's records on the system (at least assuming that any maintenance fees are paid). Thus according to the present invention, a patient can move any and all of the patient's medical records on the system from healthcare professional to healthcare professional. The patient can, keep their medical records on the invention's system throughout their entire lifetime, if so desired.

The system may often be configured to be a multi-user system that can manage a plurality (typically thousands or more) of different patients and different healthcare professionals irrespective of healthcare professional group practice or geographic location.

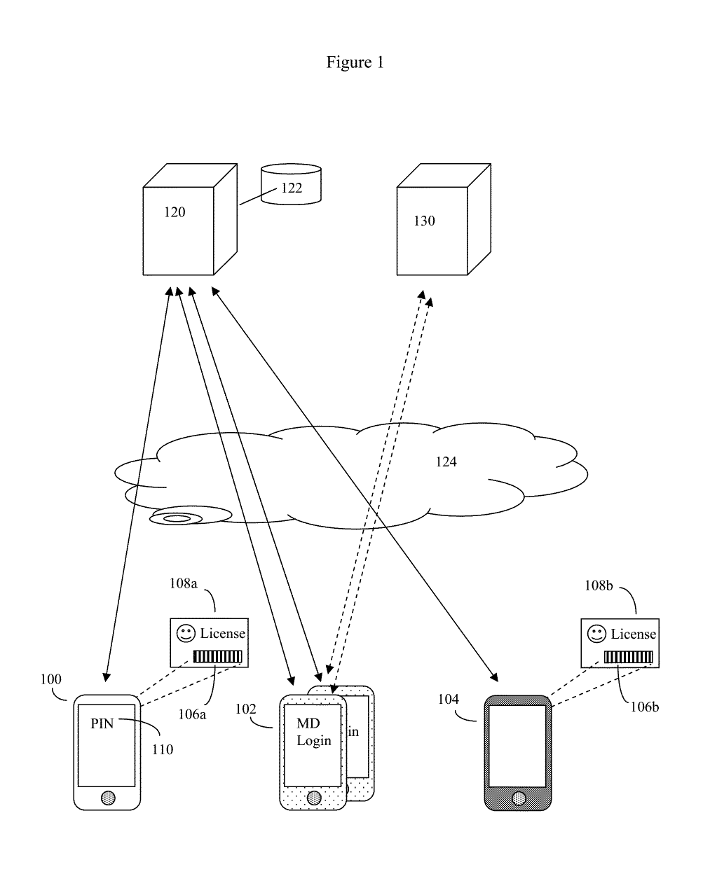

FIG. 1 shows the invention's unified patient-controlled client-server medical record system operating (over the Internet) with different client computerized devices operated by patients (100), healthcare professionals (HCP) such as physicians and laboratories (102), and emergency medical services (104).

The patient (here assumed to be previously registered) gets highest level access by providing both a machine readable ID code (here a bar code 106a affixed to a driver's license 108a) and a PIN number (110). Some previously linked and patient-authorized healthcare professionals may also get high level access via their own client computerized devices (102) and HCP login authentication methods. In emergencies (e.g. an unconscious patient found carrying a machine readable ID containing driver's license or bracelet), emergency medical services can immediately get low level access to important information such as patient identification and emergency contact numbers by using their client computerized devices (104) to scan the patient's machine readable ID code (106b).

The invention will typically operate using at least one computer server (120) and associated database(s) (122) that connects to the various client computerized devices (100), (102), (104) using a computer network such as the Internet (124).

In some embodiments, the invention can also work in parallel with legacy electronic medical records systems, exemplified here by server (130).

The servers (120) described herein should be assumed to comprise at least one computer processor (often from the popular x86, ARM, MIPS, POWERPC or other processor family), memory, an operating system (often Unix, Linux, Windows, and the like) and various other support software such as webservers (e.g. Apache), database software (e.g. MySQL), and various scripting languages such as PHP, Perl, Python, and the like. The servers will typically have at least one interface to at least one computer network, which will often be the Internet (124).

The client computerized devices (100, 102, 104) described herein should be assumed to also comprise at least one computer processor, (often from the popular x86, ARM, MIPS, POWERPC or other processor family), memory, an operating system (often iOS, Android, Linux, Windows, and the like), a user interface (often a high resolution bitmapped display screen, which may be a touch sensitive display screen) as well as optional keyboards and optional pointing devices (e.g. computer mice) and the like. The client computerized devices may also be equipped with various sensors to receive machine readable ID codes, such as cameras, bar code scanners, microphones, fingerprint readers, radio frequency identification device (RFID) readers, Near Field Communication (NFC) readers, and the like.

In some embodiments, the client computerized device(s) may be Smartphones or tablet computers, in which case the Smartphone or tablet computers will generally have a network connection to the Internet (often via wireless cellular telephone networks or WiFi connections). In other embodiments, the client computerized devise may be laptop computers, desktop computers, and the like, again connected to the server (120) via a network connection such as the Internet (124).

Unless otherwise specified, the methods described herein are automatic software implemented methods generally intended to be run under the control of the server processor(s). Any user interfaces shown herein should be assumed to be user interfaces displayed by client computerized devices (either in a web browser running on the client computerized device, app running on the client computerized device, or other software running on the client computerized device). However generally the user interfaces will be showing data obtained from the server using a network connection.

To satisfy various data security requirements, exemplified by the Health Insurance Portability and Accountability Act (HIPAA) requirements, often the system will be configured with at least a two-factor authentication process that may often operate according to something that the patient has (e.g. a machine readable ID code) and something that the patient knows (e.g. a patient known password/passphrase such as PIN number). Note that in this document, “PIN numbers” should be construed broadly as being any information known by at least the patient that the patient (or patient authorized person or entity) can communicate to a client computerized device.

More specifically, the invention may operate by, on a per patient basis, using at least one computer server (120) to associate a machine readable ID code (e.g. 106a, 106b) and patient PIN (110) code to each patient. This machine readable ID code may be encoded and stored by various methods. For example, the machine readable ID code may be encoded as a 1 dimensional or 2 dimensional optical code (e.g. bar code) on a token (e.g. driver's license (108a) carried by the patient. The token may be other physical objects as well, such as an article of jewelry (bracelet, necklace) or any physical object that the patient may so designate, including USB memory sticks and the like. Alternatively the machine readable ID code may be encoded by a particular patient's biometric signature, such as a patient fingerprint, facial feature, eye feature, or other body feature.

In FIG. 1, the various client computerized devices (100), (102), (104) may be network connected smartphones, such as the popular Apple iOS, or Android models. Although essentially any type of computerized device (e.g. tablet computer, personal computers, etc.) may be used for these purposes, smartphones are used as an example here because these devices are often equipped with one or more computer processors, memory, user interfaces, and various sensors. These sensors can include cameras that can be software configured to read bar codes, biometric signature reading devices (e.g. fingerprint scanners), and even wireless sensors such as radiofrequency identification (RFID) sensors or near field communication (NFC) sensors. Any of these may be used, according to the invention, to read the machine readable ID codes. As previously discussed, the machine readable ID code will generally be used to read something that the patient has (either a physical object, or some characteristic of the patient's body).

By contrast, the Personal Identification Number (PIN) is used to determine something that the patients, or one or more individuals trusted by the patient, know. This can be a short (e.g. 4-8 digit numbers) or alternatively may be an alphanumeric sequence, name, patient selection of a familiar image in a field of unfamiliar images, patient answers to a brief quiz, patient entered voice sequence, and the like.

Typically the patient's client computerized device (100) will obtain the patient PIN code (110) known by that patient (typically by using a user interface on that client computerized device), and use the client computerized device sensors to read the patient's machine readable ID code (106a). In FIG. 1, for example, the patient's client computerized device (100) sensor may be a smartphone camera mounted on the side opposite to the front screen, and this camera is obtaining the machine readable ID by scanning bar code (106a) mounted on the patient's driver's license (108a). The computerized device (100) then sends this information over the network (124) (e.g. the Internet) to server (120).

The server (120) can then use this machine readable ID code and patient PIN code to in turn allow the patient to enter (and server 120 to receive) various types of patient entered patient public data and patient entered private data on that patient's client computerized device (100). This allows server (120) to create at least a partial patient medical record comprising patient public data and patient entered private data, and store it as a partial patient medical record in computer database (122).

Upon receipt of the proper patient authentication (e.g. the server (120) receives that patient's machine readable ID code and patient PIN code), the patient can then use his client computerized device (100) to issue at least one link-to-HCP command to server (120). The server (120) upon receipt of this link-to-HCP command, can then electronically link that patient's partial patient medical record with at least one HCP (here a physician, Dr. Neeraj Kochhar will be used in subsequent examples as a specific patient-linked HCP). This link-to-HCP may be stored in database (122) or elsewhere. This process thus automatically creates at least one patient-linked HCP (here Dr. Neeraj Kochhar). This HCP will often have their own system/server (120) login authentication method (e.g. HCP login name and password), and thus this patient-linked HCP can be specifically identified by that patient-linked HCP's login information.

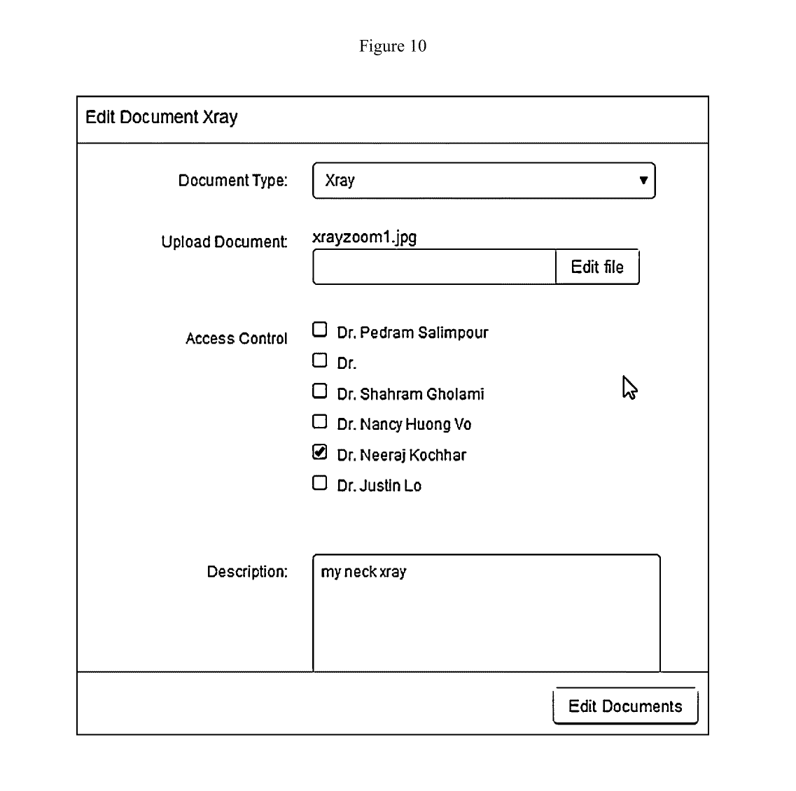

Thus for example, if patient (100) has linked to Doctor “X” using the patient's machine readable ID code and patient PIN code, and Doctor X is known to the system/server (120) by Dr. “X”'s own unique login information (which can be subject to multi-factor authentication as well), then when Dr. “X” logs in to server (120) using Dr. X's computerized device (102) and Dr. X's login information, the system server knows both that Dr. X is linked to the patient (100), and that Dr. X has been authenticated using Dr. X's client computerized device (102), therefore the system gives Dr. X access to that patient's medical records to the extent authorized by patient (100). This authorization process is discussed in more detail in FIG. 10.

Once authenticated to the server (120) and linked to the patient (100), the HCP (here again Dr. X) can (if desired) use his server authenticated computerized device (102) to transmit additional medical data relating to patient (100) to the server (120), and the server (120) can store it in database (122).

Put alternatively, the invention can use server (120) to receive at least one patient-linked HCP entered private data (e.g. private medical data relating to patient 100) from the patient-linked HCP (here Dr. X using his device 102), and store this data in the computer database (122). This ends up creating, for each patent (e.g. 100), a HCP annotated patient medical record comprising both the partial patient medical record and the at least one patient-linked HCP entered private data.

So in other words: the partial patient record is composed of the patient public data (often available to emergency medical services) and the patient entered private data. The HCP annotated patient medical record comprises both this partial patient medical record (e.g. the patient public data and the patient entered private data) and the HCP entered private data.

Once this data is stored in the server (120) and database (122), it may be retrieved by various persons, including the patient, various patient-authorized healthcare professionals (HCP) and by emergency medical services (which again may be considered to be a type of HCP). Thus for each patient, records or data from the database (122) may be retrieved by any of the following methods.

Situation 1 (low level access, particularly useful for emergency medical services use): The server (120) receives just the patient's machine readable ID code from a client computerized device (104). Here for example, if emergency medical services find that patient (100) is unresponsive, they can, for example retrieve the patient's driver's license (108a) or examine the patient for a suitable alert bracelet or necklace and the like, and scan an optical code such as bar code (106a).

They can obtain this machine readable ID code by, for example, using their emergency medical services client computerized device (104) to either run a machine readable ID code obtaining app, or download a suitable machine readable ID code obtaining web page from server (120), or use other types of machine readable ID obtaining software running on device (104).

When the server (120) receives the machine readable ID code, but not the patient's PIN, and possibly some optional code identifying device (104) as an emergency medical services device, server (120) can designate (at least for this session) this emergency medical services device (104) as an unauthorized client computerized device. The server can be configured to then transmit the patient's previously entered public data over network (124) to unauthorized client computerized device (104), but not transmit the higher privacy portions of the patient medical record.

Situation 2 (medium level access, typically used by various healthcare professionals such as physicians): The server (120) receives HCP login information from at least one HCP that was previously linked to that patient (e.g. the server receives at least one linked HCP login information, such as the HCP's email address and password). This can be done by receiving data over the network (124) from the HCP's client computerized device (102). The server (102) (and associated server software) are configured to then automatically designate (at least for this session) client computerized device (102) as a patient-linked HCP client computerized device. The server can then transmit at least the partial patient medical record to this patient-linked HCP client computerized device (102) for subsequent viewing by that HCP. Note that often, if the patient has authorized that HCP to also receive various items of patient-linked HCP entered private data, then the HCP may receive more than just the partial patient medical record, up to and including the full HCP annotated patient medical record.

Situation 3 (highest level access, generally used by the patient): The server (120) receives both the patient's machine readable ID code and the patient PIN code from a client computerized device (100). The server is configured to thereby designate (at least for this session) this client computerized device as a patient authorized computerized device. The server can then transmit (as desired by the patient) up to the entire HCP annotated patient record over network (124) to this patient authorized computerized device (100).

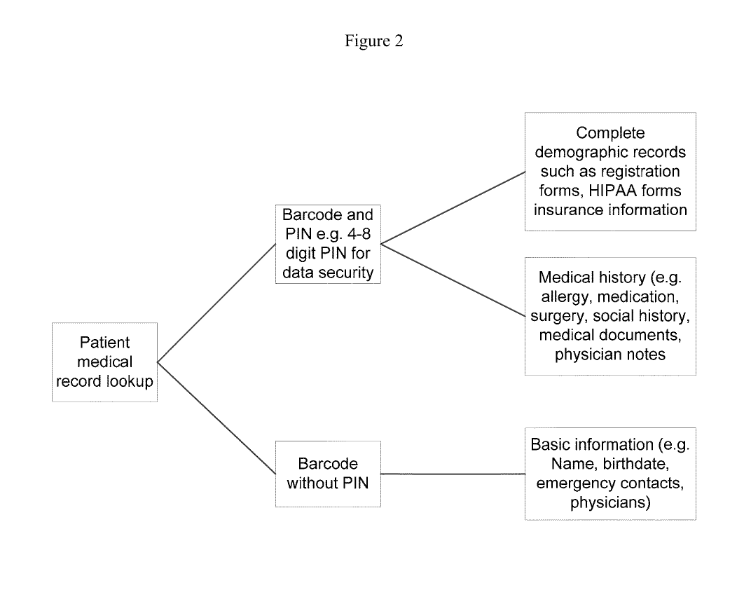

FIG. 2 shows a chart illustrating how use of only machine readable ID codes (such as bar codes) results in only low level access, while use of machine readable ID codes (such as bar codes) and supplemental codes that the patient or caregiver know, such as PIN codes, provide the highest level access.

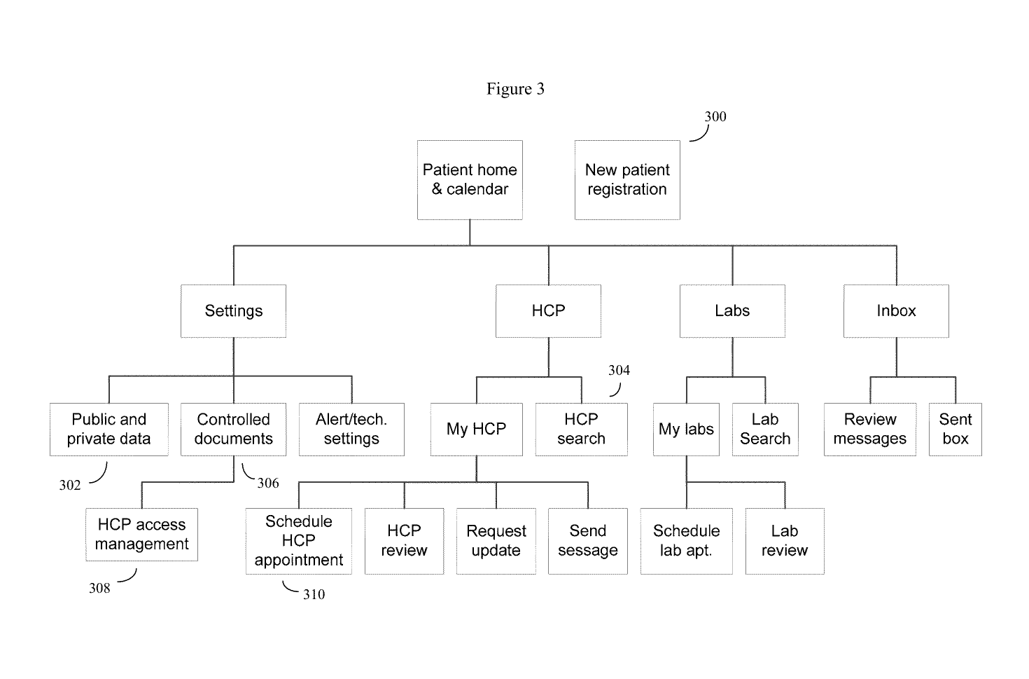

FIG. 3 shows a chart showing some of the major features of the patient side of the unified patient-controlled client server medical record system. As will be discussed, in addition to allowing for patient controlled medical records, the patient side of the system (e.g. software running on server 120) can be configured to do additional functions, such as new patient registration, linking new HCP into the system (or deleting previously linked HCP) sending and receiving messages to various linked HCP, running various appointment calendars with various linked HCP, and the like.

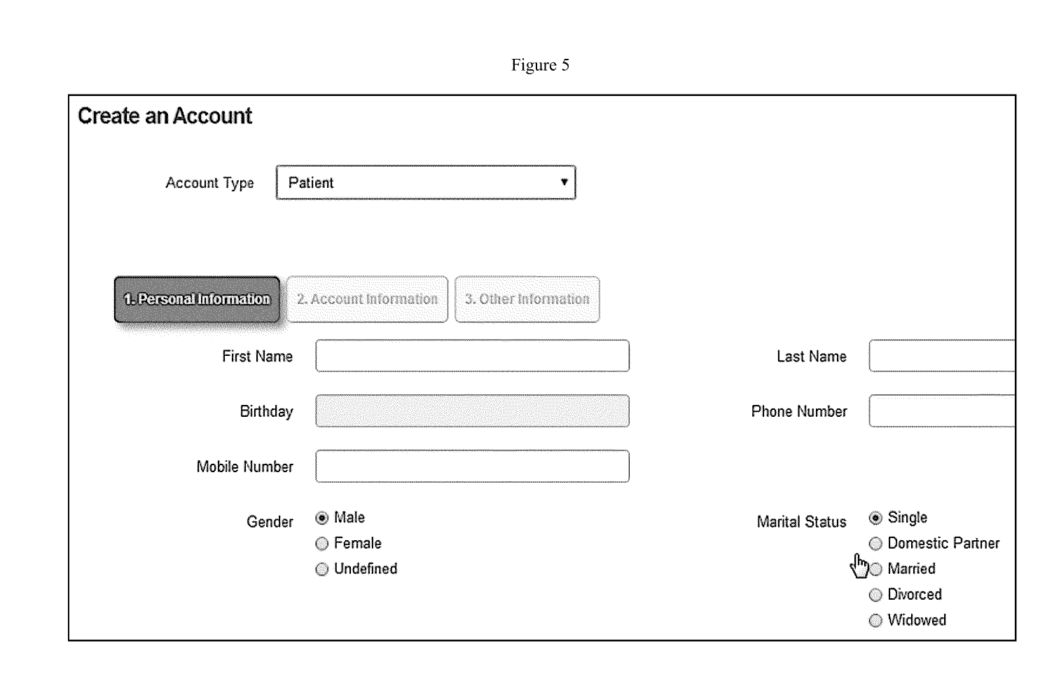

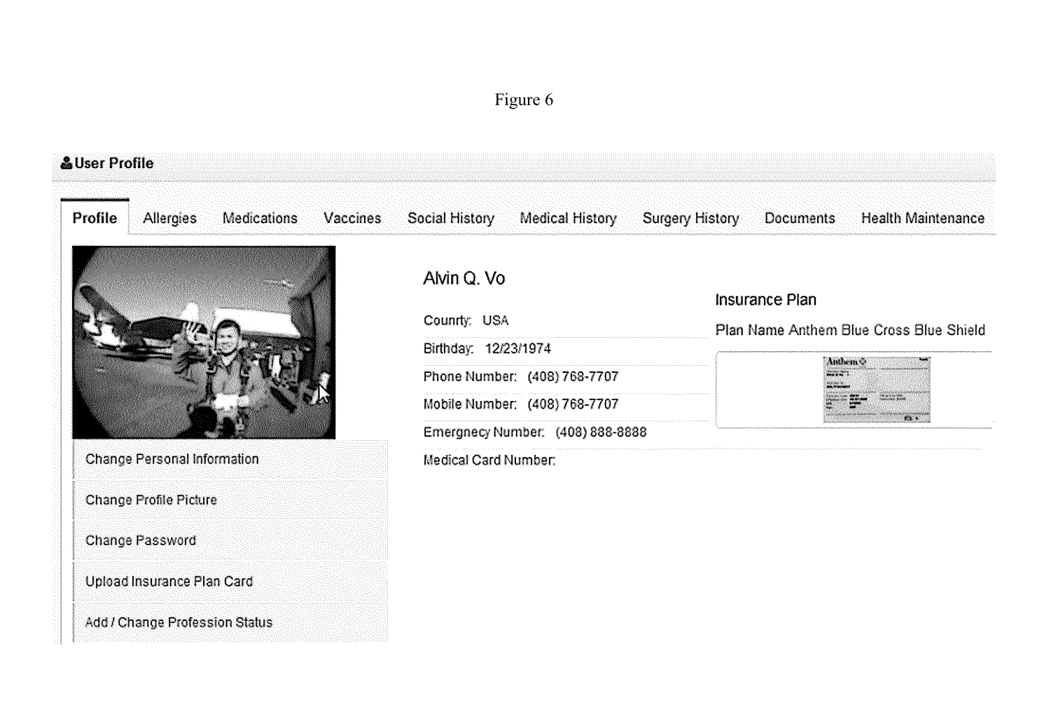

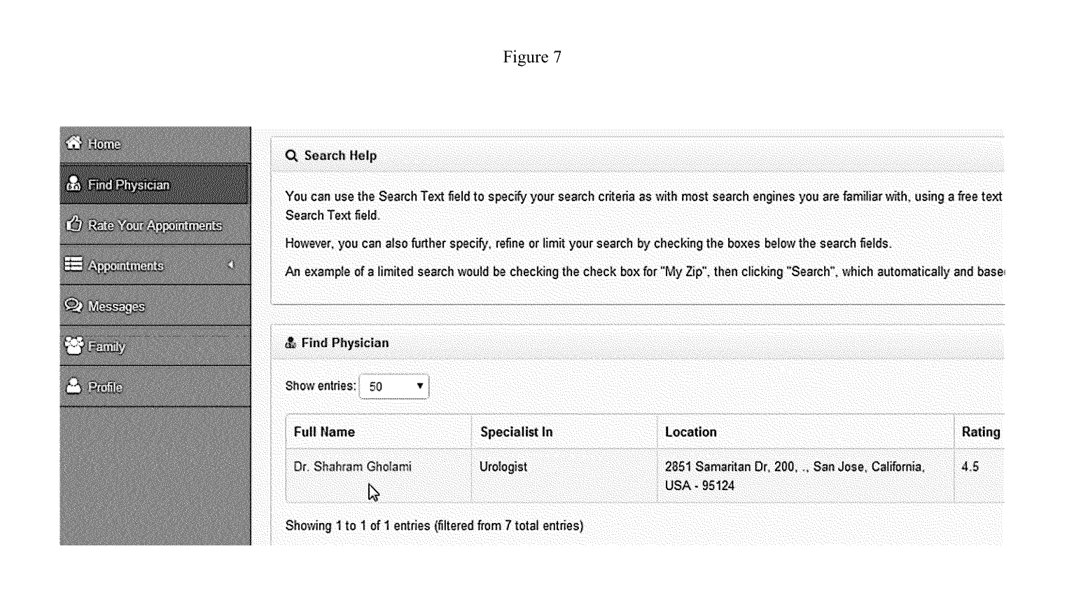

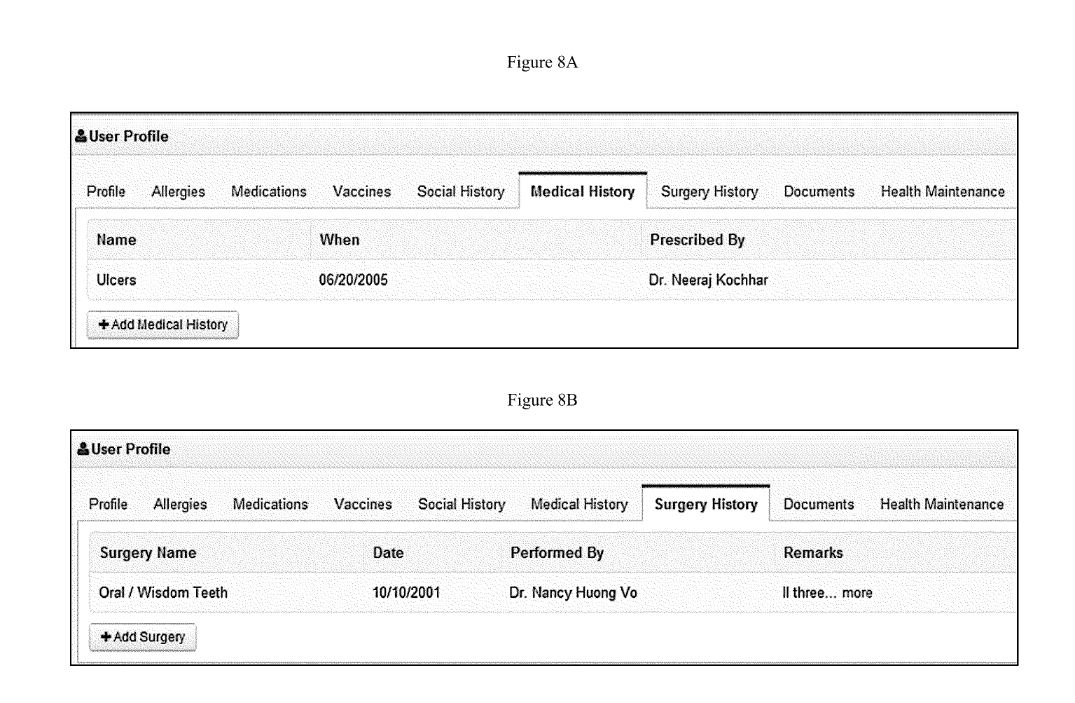

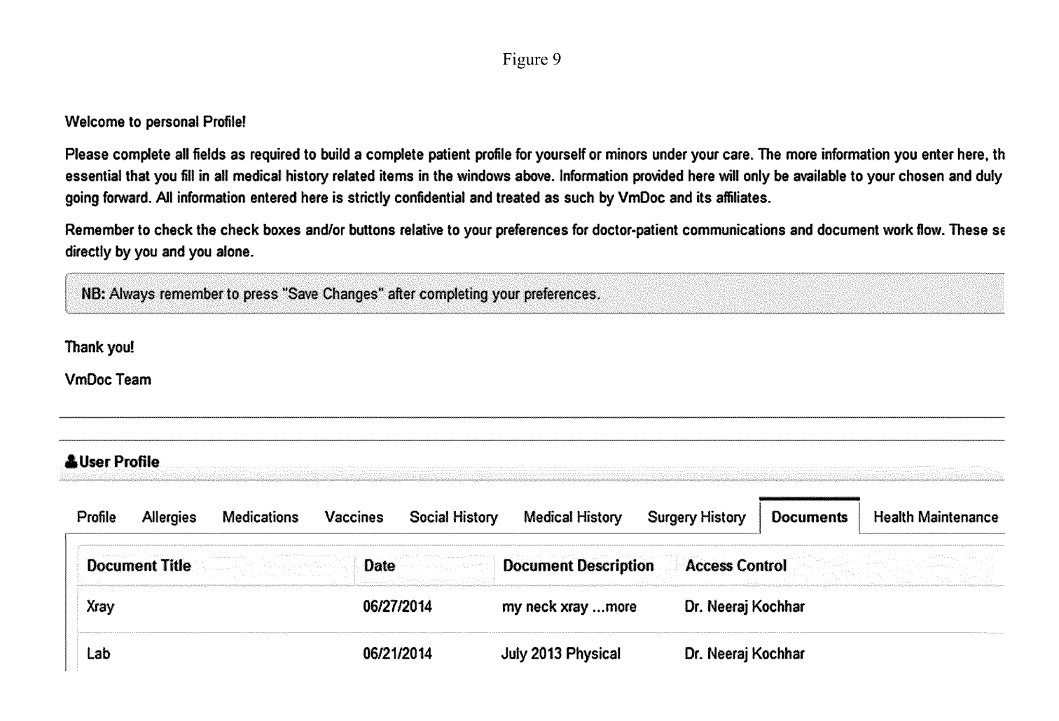

Here the new patient registration process (300) is shown in more detail in FIG. 5. Certain aspects of patient public and private data (302) are shown in more detail in FIG. 6 (patient profile), as well as FIG. 8A (medical history), FIG. 8B (surgery history), and patient documents (FIG. 9). A patient conducted search for HCP to link to (304) is shown in FIG. 7.

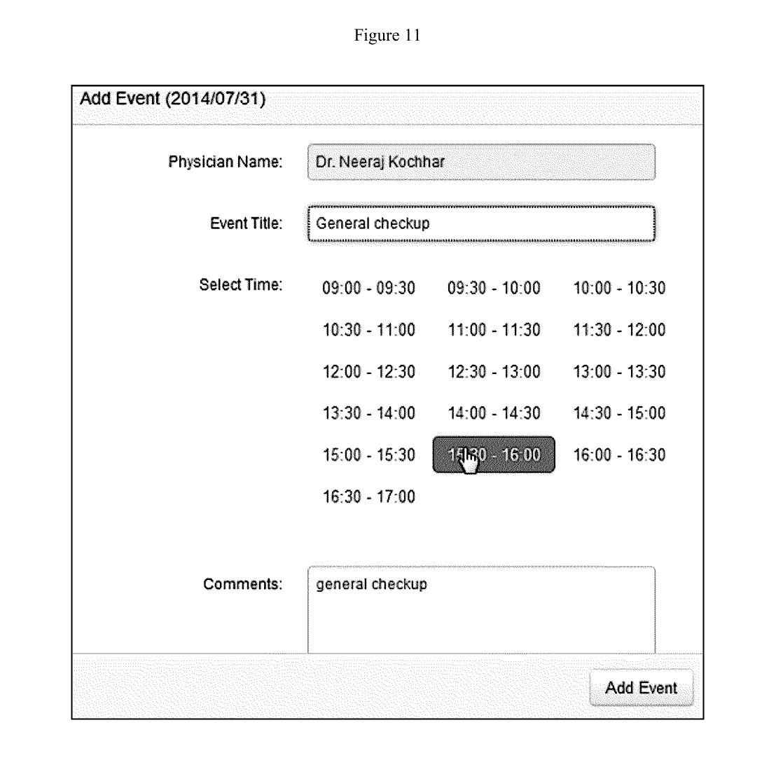

Various patient and HCP entered patient controlled documents (306) are shown in FIG. 9, and HCP document access management (308) is shown in FIG. 10. HCP scheduling (310) is shown in FIG. 11.

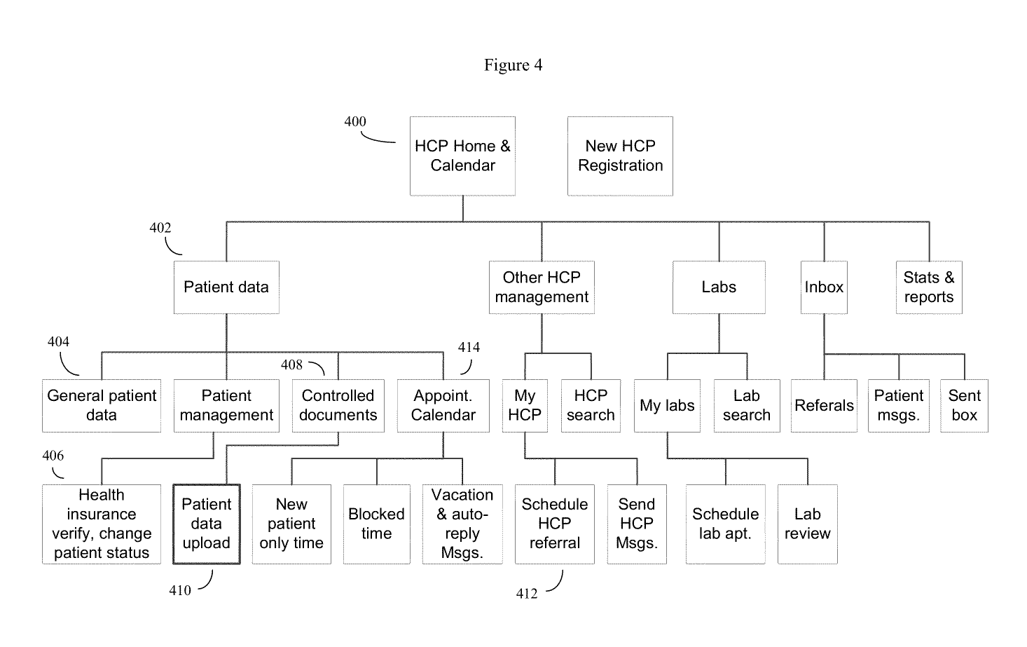

FIG. 4 shows a chart showing some of the major features of the HCP side of the unified patient-controlled client server medical record system. As will be discussed, in addition to allowing various healthcare professionals to enroll in this patient controlled system, the system (e.g. software running on server 120) can be configured to do additional functions, such as allowing HCP to receive and accept requests to be linked to particular patients, sending and receiving messages to various linked patients, running various appointment calendars with various linked patients, referring patients to other linked HCP, uploading patient-linked HCP entered private data, and the like.

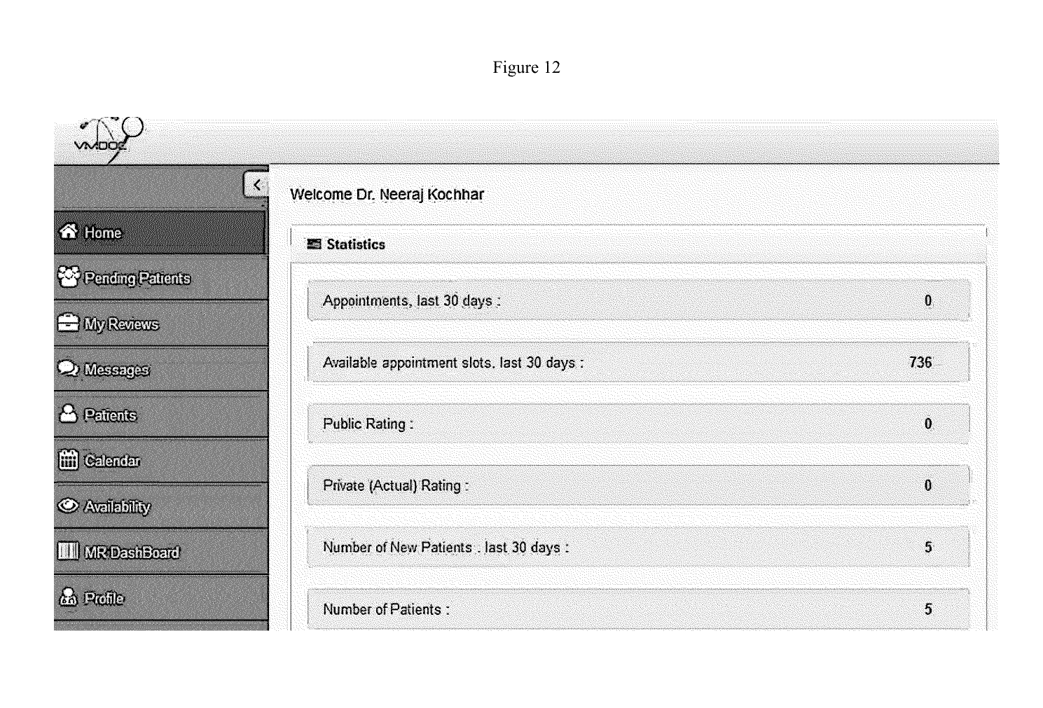

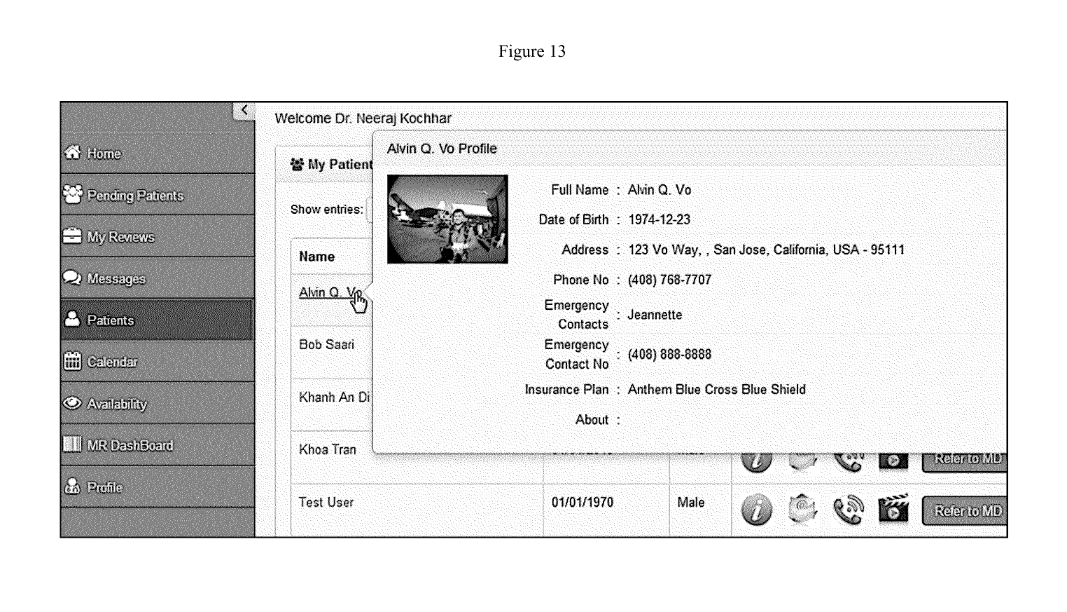

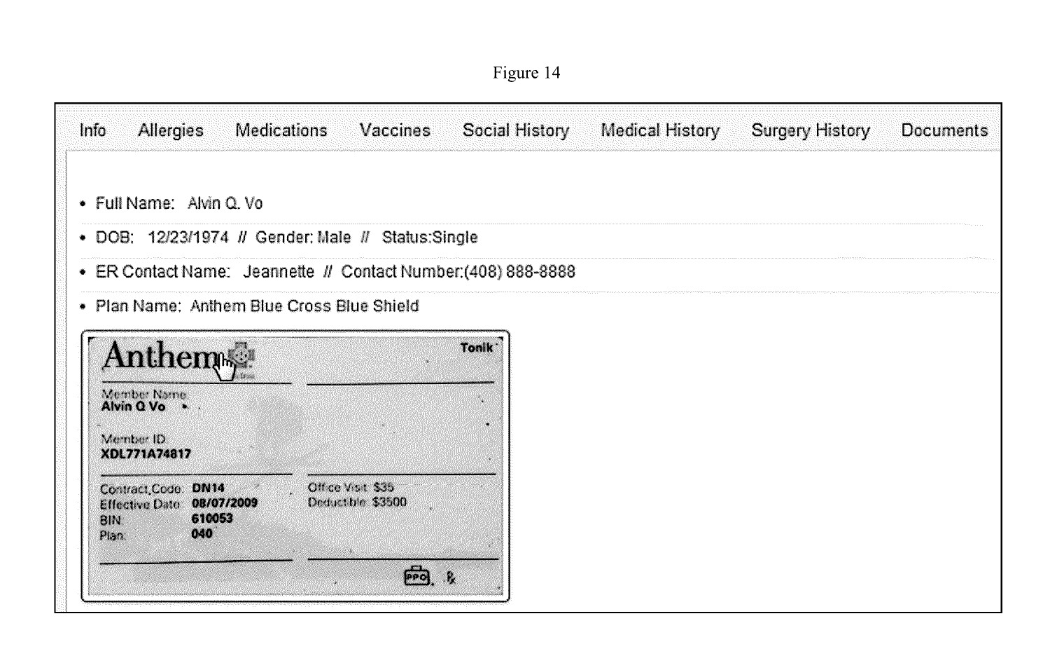

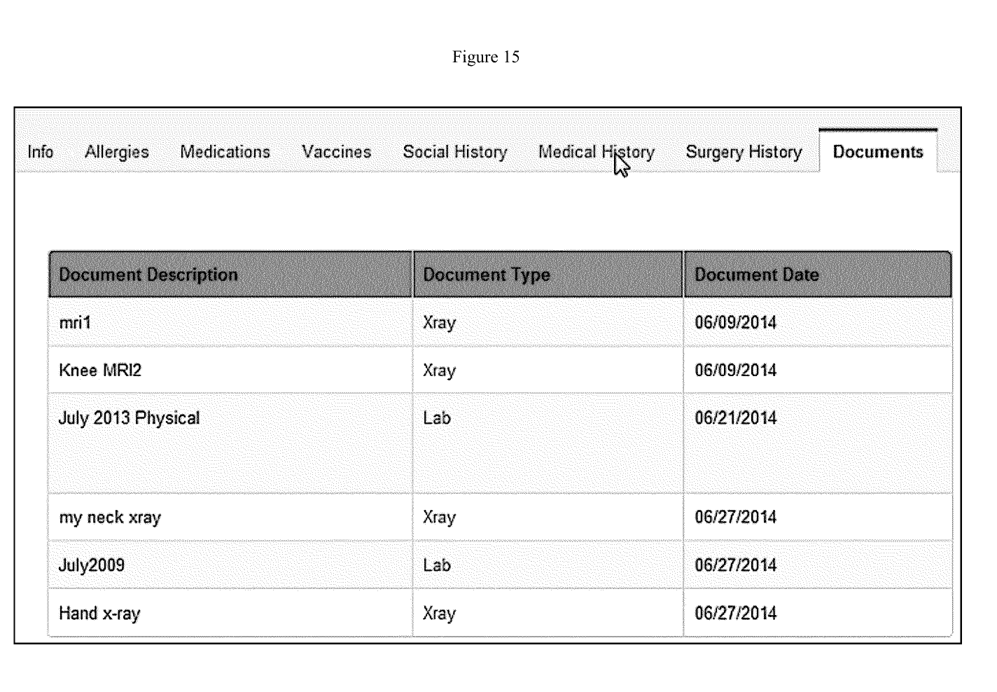

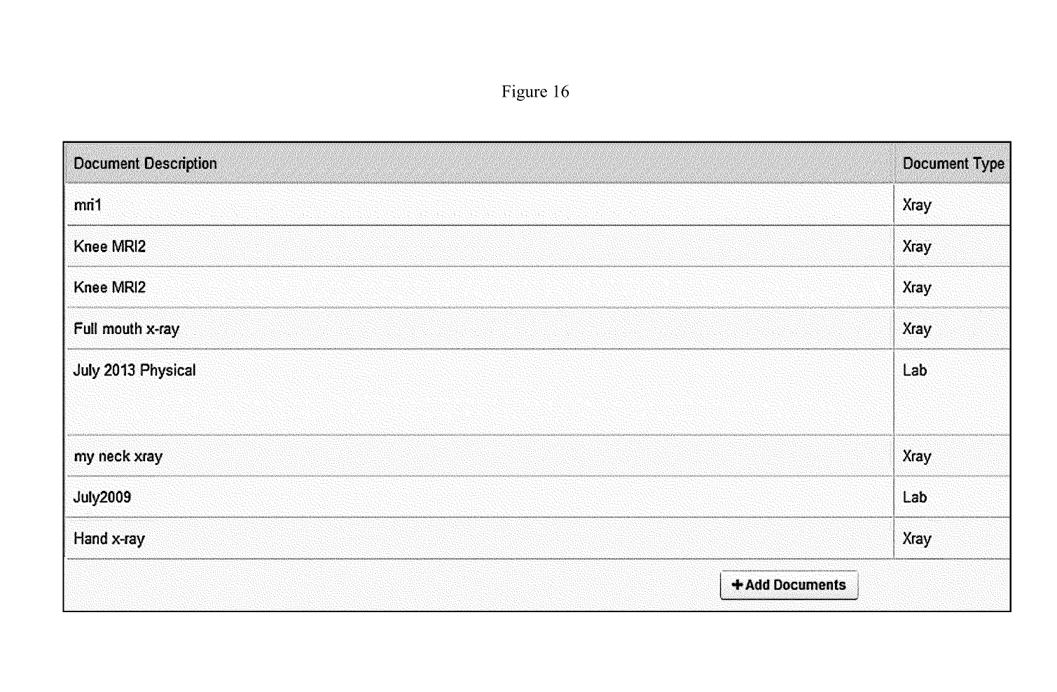

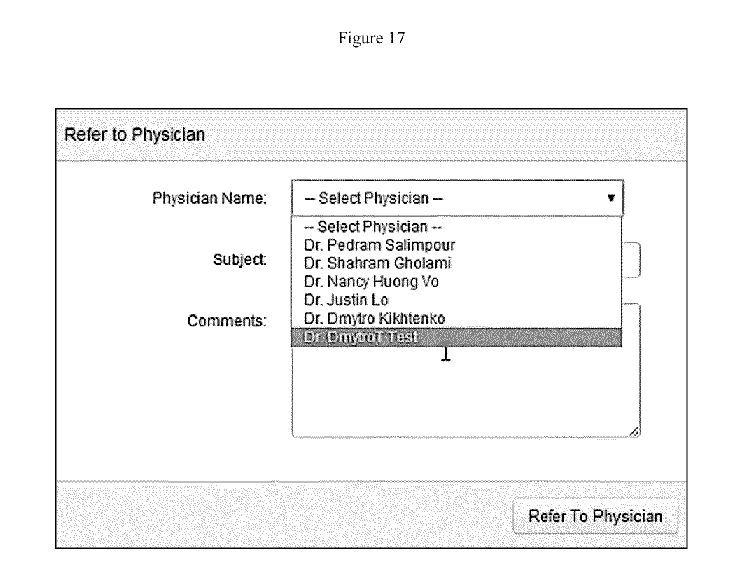

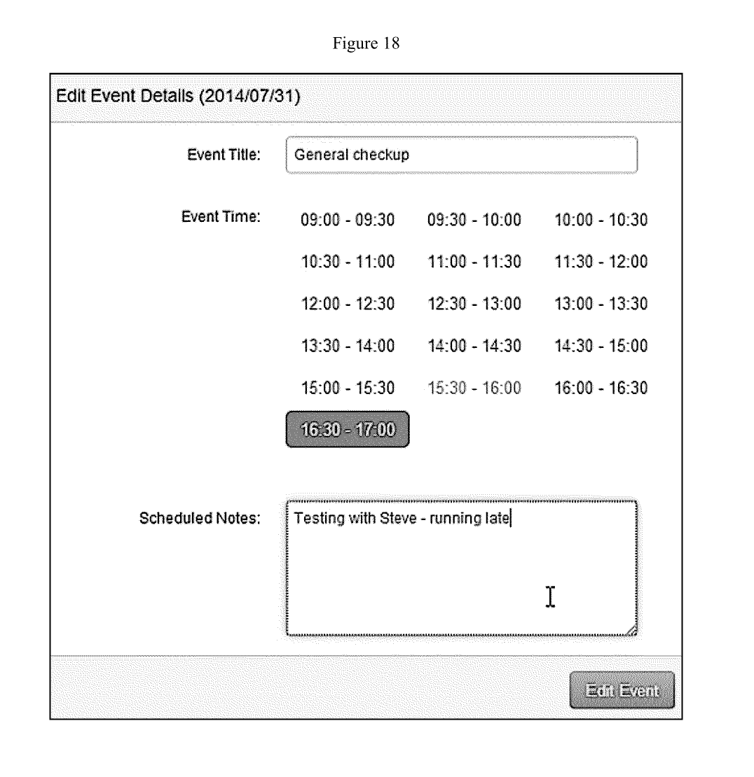

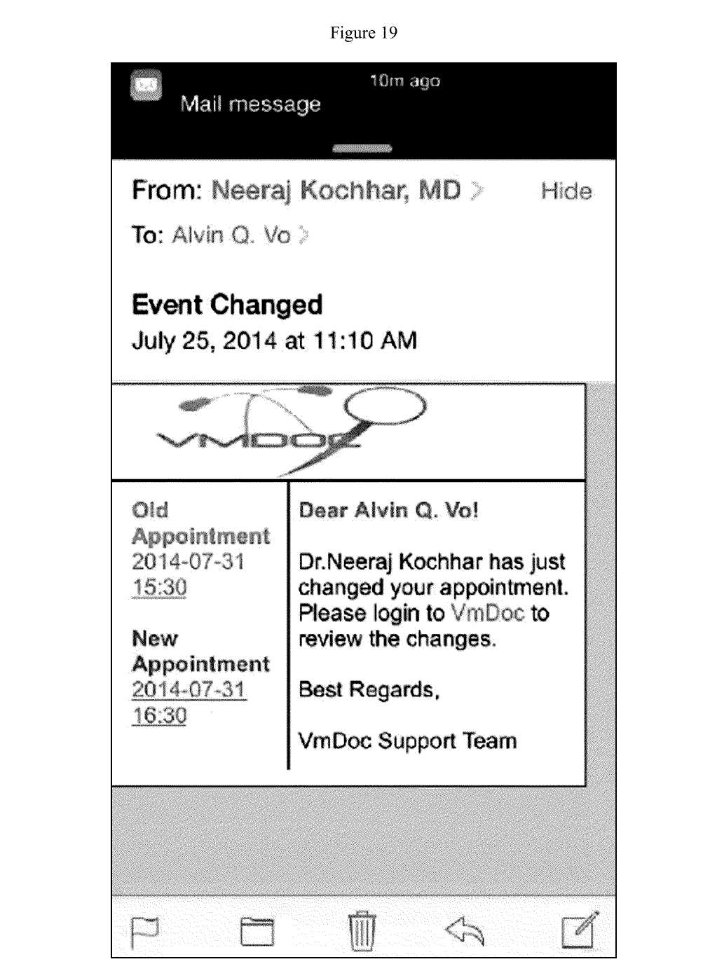

In FIG. 4, the HCP home screen (400) (here configured to also provide some statistical data) is shown in FIG. 12. The general patient data (402) and more specific data about a particular patient (404) are shown in FIG. 13. Review of patient health care coverage (406) is shown in FIG. 14. Review of various controlled patent healthcare documents (408) is shown in FIG. 15. HCP uploads of additional controlled patient notes and healthcare documents (410) are shown in FIG. 16. Referral to other HCP (412) is shown in FIG. 17. Appointment calendar management (414) is shown in FIGS. 18 and 19.

FIG. 5 shows how the patient first can initialize and take control of the system by opening a new patient account. New HCP registration can generally be similar, except that the HCP is given a lower level of control over the system (medium level access).

### Patient Side of System

FIGS. 6-11 focus on the patient side of the system, previously reviewed in FIG. 3.

FIG. 6 shows an example of a patient entered general profile. This general profile will often comprise patient public data (e.g. data that can be transmitted to emergency medical services), such as the patient's name, contact information, emergency contact information, healthcare insurance and the like. Other data (e.g. profile pictures, profession, etc.) may also be entered as the patent desires. Patients with urgent medical conditions (e.g. diabetes) may also disclose this on their general profile for possible future use by emergency medical services, as desired.

FIG. 7 shows how the patient may control which physicians or other healthcare professionals to add (e.g. to be linked to) to the patient's personal system by selecting from a list of potential healthcare professionals (here a list of local physicians). If the healthcare professional accepts the patient's invitation, then the healthcare professional is then linked with that patient's particular medical record. Patients may also unlink HCP as the patient desires (not shown).

To do this, server (120) and database (122) can be configured with a list of HCP, and the server can then transmit at least portions of this list of HCP over the network (124) to the patient's client computerized device (100). The patient can then use their client computerized device (100) to select at least one HCP from this list of HCP, thereby creating at least one selected HCP, which the client computerized device (100) can then transmit to the server (120). Assuming that this HCP accepts the invitation (often by so indicating on the HCP's client computerized device 102), then the server (120) can use this at least one selected HCP to electronically link that patient's partial patient medical record with this at least one selected HCP, thereby creating at least one patient-linked HCP (in the examples, Dr. Neeraj Kochhar is the patient-linked HCP). This at least one patient-linked HCP will typically logon to the server (120) using that HCP's particular login information (e.g. login name and password) and/or other HCP authentication information as desired. Thus the server (120) can identify this at least one patient-linked HCP by this HCP's particular login/authentication information.

As a result, if the patient-linked HCP logs out of his client computerized device (102), then logs back to the server (120) using either that client computerized device (102) or other client computerized device, and if this HCP provides the correct login or other authentication information, then server (120) will once again recognize that this HCP is a patient-linked HCP with regard to those patients that have linked with this HCP.

Alternatively, in some configurations, the patient may wish to avoid having the HCP use his or her own HCP login methods, and instead require that the HCP instead login using the patient's machine readable ID and patient PIN number. Although workable, this alternative method is generally is less favored because the HCP will then have full access and control of the system (at least while the patient is present). This also in effect nullifies the HCP side of the system, rendering various other functions useless.

FIGS. 8A and 8B show various examples of how the patient may view and enter their particular private data, such as medical history records and surgical history records, into the system. This patient entered private data can, for example, comprise data such as patent profile information, allergies, medications, vaccines, social history, medical history, dental history, surgical history, documents, and health maintenance schedules.

FIG. 9 shows how the patient may also view and enter in various medical documents (here these may be older documents such as vaccination records and the like that the patient may have previously obtained from various healthcare professionals) into the system. Suitably authorized healthcare professionals can also add additional medical documents here as well. Note that this screen also reminds the patient about which HCP are allowed to view these various medical notes and documents. Here the patient has previously decided to grant access to these documents to Dr. Neeraj Kochhar, and this is shown. The access control interface is shown in more detail in FIG. 10.

Put alternatively, in some embodiments, the patient may have linked more than one HCP to the system (e.g. a primary doctor and a dentist) but may not always want to share all documents (such as various documents entered in by various patient-linked HCP) with all HCP. The patient may for example not want to share all private medical information, such as sensitive medical information obtained from his physician, with his dentist.

In one simplified example, assume that the various patient-linked HCP comprise at least a first patient-linked HCP (e.g. a dentist) with a first patient-linked HCP login information (e.g. the dentist's login credentials), and a second patient-linked HCP (e.g. a physician) with a second patient-linked HCP login information (e.g. the physician's login credentials).

In this embodiment, the patient can use server (120) to receive the patient's machine readable ID code, patient PIN code, and “HCP data access privileges” (see FIG. 10) from the patient's client computerized device (100). These “HCP data access privileges” are the patient's permission (or lack of permission) to allow (or not allow) the first patient-linked HCP (e.g. the dentist) to view either:
a) View any specific patient-linked HCP entered private data entered by the second patient-linked HCP (e.g. the dentist can view all private medical records entered in by the patient's physician).
b) View only specific patient-linked HCP entered private data entered by the second patient-linked HCP (e.g. the dentist can view only some of the private medical records entered in by the patient's physician)
c) View none of the patient-linked HCP entered private data entered by the second patient-linked HCP (e.g. the dentist can view none of the private medical records entered in by the patient's physician).

According to these patient permissions above, the server (120) then transmit (or does not transmit) the patient-linked HCP entered private data entered by the second patient-linked HCP (e.g. the private medical records entered in by the patient's physician) to a patient-linked HCP client computerized device operated by the first patient linked HCP (e.g. the dentist's computerized device, so identified by the dentist's particular login or other authentication codes).

FIG. 10 shows an access control configuration screen where the patient decides which healthcare professionals will be allowed access to a particular medical document. The patient maintains control of the system here. In this example, the patient has granted access to his neck x-ray records Dr. Neeraj Kochhar. This was also previously shown in FIG. 9.

In some embodiments, the invention may also use the server (120) to run calendar based software such as client appointment scheduling software. This can be used to help schedule appointments between the patient and the patient's various patient-linked HCP. This is shown in

FIG. 11, which shows how a patient may also make use of the system to request an appointment with a particular healthcare professional at a particular time and date.

Often the appointment scheduling process will be a cooperative process in which the HCP, working with the HCP side of the system, may first make an appointment calendar available designating various days and times when the HCP is available for new or existing patients, as well as times when the HCP in not available (e.g. blocked time, vacation schedules, and the like, previously shown in FIG. 4). The system will often make at least some of the HCP's appointment calendar information available to patients, so that the patients may see what times the HCP may be available for appointments.

Here in FIG. 11, assume that the patient has already checked the scheduling calendar for that HCP and has that the patient has already seen that the HCP was available at that day and time.

When the patient requests an appointment, generally the HCP will wish to confirm the appointment. Additionally the HCP may need to change the patient entered appointment time/date if conflicts arise after the appointment was originally scheduled.

To see the system handling HCP based appointment rescheduling, we will now need to switch our attention from the patient side of the system (FIG. 3) to the physician (HCP) side of the system (FIG. 4). After a brief review of a few physician side HCP functions, we will then return (in FIGS. 18 and 19) to an example of what may happen when the HCP receives this FIG. 11 patient request for an appointment.

### HCP Side of System

FIGS. 12-18 focus on the HCP side of the system, previously reviewed in FIG. 4.

FIG. 12 shows the login screen of a healthcare professional (here a physician) after logging in to server (120) using the physician's client computerized device (102). Here assume that the HCP has previously enrolled in the system (created an HCP account) as an HCP using a user interface similar to that shown in FIG. 5). Also assume that the patient had previously linked to the HCP using a user interface similar to that shown in FIG. 7, and that this HCP has accepted, and thus this HCP is a patient-linked HCP.

Before returning to the fate of the patient request for an appointment, previously shown in FIG. 11, we will briefly review a few aspects of the HCP side of the system.

FIG. 13 shows how the healthcare professional can review their list of linked patients, and review profile data for specific patients. Here this patient-linked HCP, perhaps getting a notice that patient Alvin Vo, has requested an appointment, may want to first refresh his memory of Alvin's general profile. One question immediately may come to mind, what is Alvin's present insurance status?

FIG. 14 shows how the healthcare professional can review the insurance data provided by a particular linked patient. Here the patient-linked HCP is able to verify that Alvin's health insurance is up to date and that it would likely cover the requested appointment.

The patient-linked HCP may next wish to review this patient's medical documents. Here assume that patient Alvin Vo has previously given this HCP access to all of Alvin's medical records, so the list of documents available to this patient-linked HCP is thus relatively complete. This is shown in FIG. 15. Again, remember that the information shown is obtained from server (120) and database (122), transmitted over a computer network such as the Internet (124) and is being displayed on the display screen of the patient-linked HCP's client computerized device 102).

If the patient-linked HCP wishes to update patient Alvin Vo's medical records (perhaps the results of a new test have just arrived, and the patient-linked HCP wishes to upload these test records), then the patient-linked HCP can upload these documents using the “+Add Documents” user interface shown at the bottom of FIG. 16. This allows the patient-linked HCP to enter in various types of private medical data pertaining to the patient, such as that HCP's notes, HCP entered documents, HCP entered image data, laboratory reports, etc.

In some embodiments, these documents may be obtained from the patient-linked HCP's legacy medical record system such as from a legacy medical documents server (e.g. third party electronic medical record system) (130) and imported into the invention's system server (120) using client computerized device (102). Here various methods of importing data, including cut and paste (if permitted by the client computerized device and legacy medical documents system), saving legacy medical records from server (130) as electronic files, and then importing the various electronic files into the invention's server (120) using the user interface shown in FIG. 16, direct electronic transfer methods between legacy server (130) and invention server (120), and other data transfer methods may be used.

Since a key aspect of the invention is to provide a patient controlled medical system, an important objective is to ultimately place any data uploaded by the HCP under patient control, thus extending the lifetime of this data for so long as the patient desires. At the same time, the various patient-linked HCP may occasionally make mistakes in uploading data, or have second thoughts regarding the uploaded data.

Here removing any ability for HCP edits could potentially discourage use of the system, as well as lead to uncorrected errors. To overcome these problems, the HCP should ideally be able to edit their HCP uploaded data for at least a limited period of time.

Thus in some embodiments, the system server (120) will often be configured to allow the patient-linked HCP entered private data be editable by their entering HCP for at least a limited time period. This limited time period can be fixed by system policy (e.g. 1 week allowed for any HCP edits after the HCP initially uploads data). Alternatively, HCP editing ability may be adjusted under patient control (e.g. patient selects periods where HCP editing of HCP uploaded data is allowed that may range from 1 day after uploading to a year or more after uploading).

However after this limited editing time, the HCP entered private data will then become permanent and unalterable, at least by the patient-linked HCP (in some embodiments, the patient may still be allowed to edit). After the data has become unalterable, the patient-linked HCP may still correct mistakes by entering in supplemental documents with corrections, but the original documents will still remain available on the system, with their later corrected status optionally indicated by various system indicators (e.g. corrected by document “xyz on date”, “obsolete”, “subsequently corrected”, and the like).

HCP are often specialized, and it is not uncommon for a general practitioner to refer a patient to a specialist physician, or a dentist to refer a patient to a dental surgeon, and the like. FIG. 17 shows how the healthcare professional may also use the system to automatically refer the patient to another healthcare professional.

Returning now to our patient Alvin Vo, who has been waiting since FIG. 11 for his patient-linked HCP, Dr. Neeraj Kochhar, to respond to his appointment request. Assume that in FIG. 18, Alvin's patient-linked HCP, Dr. Kochhar, is generally willing to schedule an appointment that day, but that something has come up at the last minute, and that the 15:30 to 16:00 (3:30 to 4:00 PM) time slot originally proposed by the patient is now inconvenient. In FIG. 18, the HCP thus responds to the original appointment request by proposing an alternative 16:30 to 17:00 (4:30 to 5:00 PM) time slot on the same day. The HCP also provides a brief reason for the rescheduling request. This request for rescheduling is transmitted from the HCP's client computerized device (102) to the system server (120).

In some embodiments, server (120) is configured to notify either the patient, or the patient-linked HCP, of any appointment changes by automatically transmitting a message to the various parties affected by the appointment change. The server (120) can do this notification by various methods, including automatically generated audio telephone messages, emails, SMS messages, social network messages, fax messages, and the like.

For example, FIG. 19 shows how the system server (120) can automatically notify patient Alvin Vo of the new appointment time. Here server (120) has automatically transmitted an email message to the patient's smartphone (either device 100 or other device).

Emergency medical services side

In some embodiments of the invention, server (120) may also be configured to respond to various client computerized devices (previously shown in FIG. 1 104) operated by various emergency medical services, such as ambulances, paramedics, emergency medical technicians (EMT), and the like.

In some embodiments, emergency medical services may simply be equipped with their own authentication system (e.g. emergency medical services login names, passwords, or other authentication methods). In this embodiment, the server (120) may be further configured to recognize this emergency medical services identification code (or other authentication). The server may be further configured, (often in response to prior patient consent) to transmit at least the partial patient medical record over network (124) to a client computerized device operated by emergency medical services (104).

Here for example, if server (120) receives input over network (124) from device (104) such as: “login from EMT 1234, request partial patient medical record for Alvin Q. Vo”, server (120) can then be configured to respond to this input (emergency medical services identification code and patient identifier) by recognizing client computerized device (104) as an emergency medical services client computerized device. In this embodiment, server (120) can then automatically transmit at least the partial patient record to this emergency medical services client computerized device (104). This embodiment is useful when emergency medical services may be on their way to an identified patient in distress (ether conscious or unconscious) but may not have arrived at the patient yet. The emergency medical responders may review at least the partial patient medical record in advance. In this example, if the patient has previously identified himself as being diabetic, and authorized release of this information to emergency services, then the emergency medical responders may have blood glucose monitors, glucose, or insulin available when they arrive on the scene.

In an alternative embodiment, server (120) may be configured to respond to client computerized devices that provide only the patient machine readable ID code (see FIG. 1 104 and barcode 106b as an example). This alternative embodiment may be useful for emergency medical responders arriving on the scene to find an unresponsive patient. This patient may have a bracelet, necklace, driver's license or fingerprints that can be used to provide the machine readable ID code, but because the patient is unresponsive, the patient may not be able to provide a PIN code.

Here, the emergency medical responders can still obtain at least the patient entered private data by first using their client computerized devices (104) to obtain the machine readable ID code (e.g. 106a), contact the server (120), and then obtain the patient emergency contact information. The emergency responders may also be told about other urgent medical problems that the patient cares to reveal to such lower level security access, such as the previously discussed diabetes example.

Once they have received the emergency contact information, the emergency responders can then contact the individuals or institutions or devices listed in the patient emergency contact information, and obtain the patent's PIN code (here the patient has presumably already provided this PIN code to their emergency contacts). The emergency responders can then provide the PIN code as well to the server (120) via their client computerized devices (104).

At this point, the server (120) can either designate these as patient authorized computerized devices, or alternatively (in response to additional emergency responder commands) can recognize that these devices should be recognized as a fully authorized emergency medical services client computerized device. In either case, the server (120) can then transmit as much information as needed, even up to the full HCP annotated patient record, over network (124) to the fully authorized client computerized device (104).

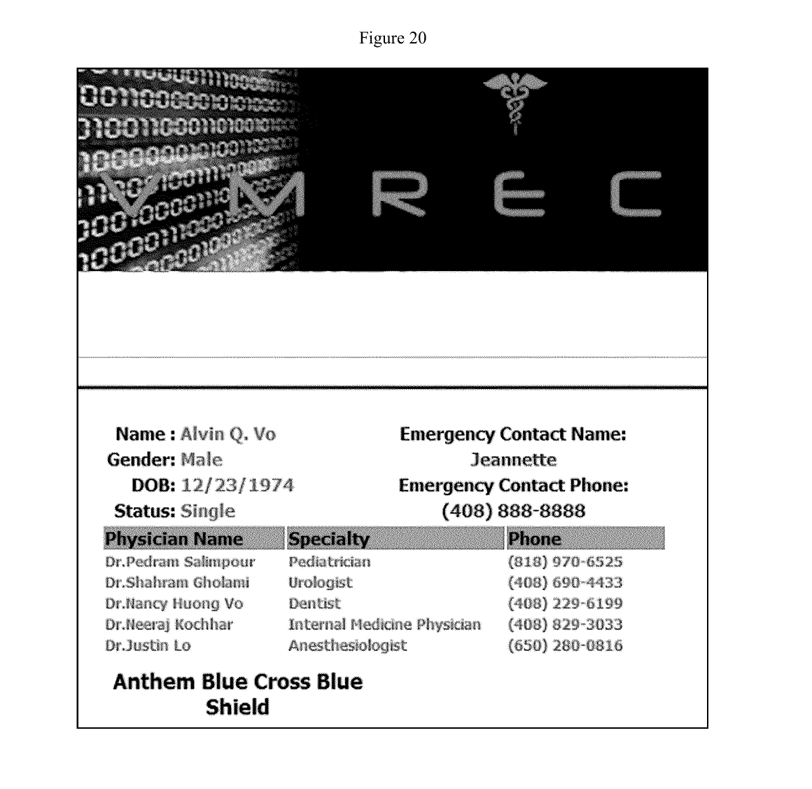

FIG. 20 shows the system operating in an emergency medical responder mode. Here an emergency medical responder, upon finding an unresponsive patient, can scan the patient's machine readable ID code (106a) and get at least low level access to the system server (120). The emergency medical responder can, for example, obtain emergency contact information (shown in FIG. 20), contact these emergency contacts, receive the patient's PIN code, and use this to then obtain up to full access of the patients medical record.

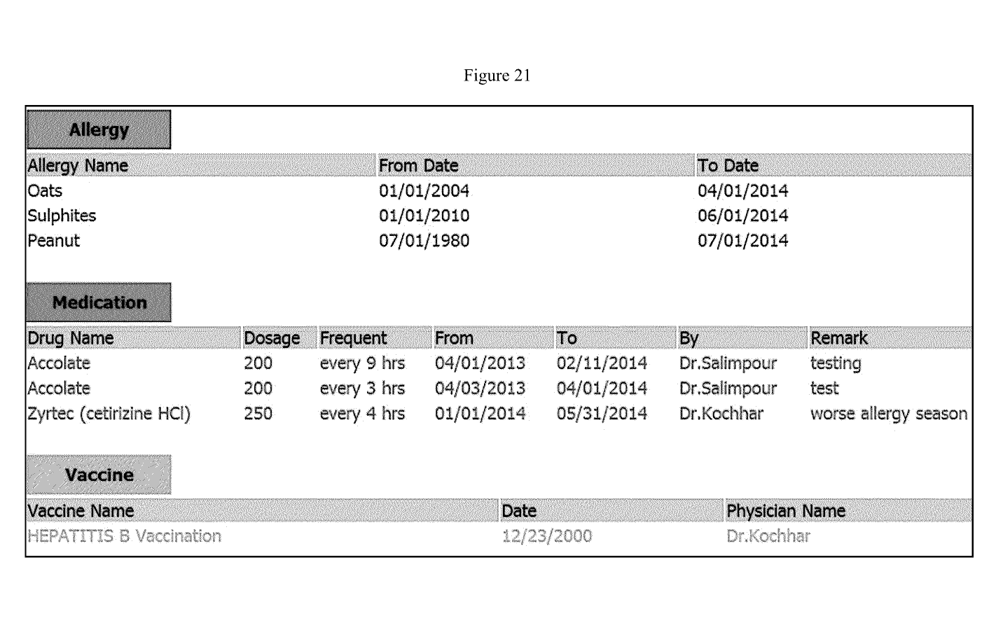

FIG. 21 shows the system then operating in emergency medical responder mode after receiving both the patient's machine readable ID code, and the patient's PIN code from the patient's emergency medical contact. In this example, the emergency medical responder has further instructed server (120) to format the medical records in a format optimized for quick reading and assessment.

1. A method of operating a unified patient-controlled client-server medical record system configured to manage a plurality of patients and HPC, said method comprising:
for each patient, using at least one computer server to associate a machine readable ID code and patient PIN code to said patient, wherein said machine readable ID code is either encoded on either a token carried by said patient or is carried by a biometric signature associated with said patient, and wherein said patient PIN code is known by said patient, and said machine readable ID code and said patient PIN code are transmitted to said server over a network using a patient authorized client computerized device;
using said machine readable ID code and patient PIN code to receive patient public data and patient entered private data from a client computerized device, thereby creating a partial patient medical record comprising patient public data and patient entered private data, and using said server to store said partial patient medical record in a computer database;
using said server to receive said machine readable ID code, patient PIN code, and at least one link-to-HCP command, and electronically link said partial patient medical record with at least one HCP, thereby creating at least one patient-linked HCP identified by patient-linked HCP login information;
using said server to receive at least one patient-linked HCP entered private data from said patient-linked HCP and store it in said computer database, thus creating for each patent, a HCP annotated patient medical record comprising said partial patient medical record and at least one patient-linked HCP entered private data;
for each patient, retrieving records or data from said database according to any of:
a) using said server to receive only said machine readable ID code from a client computerized device, thereby designating said client computerized device as an unauthorized client computerized device, and transmitting only said patient public data over said network to said unauthorized client computerized device;
a) using said server to receive at least one linked HCP login information from a client computerized device, and thereby designating said client computerized device as a patient-linked HCP client computerized device, and transmitting at least said partial patient medical record to said patient-linked HCP client computerized device;
c) using said server to receive to receive both said machine readable ID code and said patient PIN code from a client computerized device, thereby designating said client computerized device as a patient authorized computerized device, and transmitting said HCP annotated patient record over said network to said patient authorized computerized device.

2. The method of claim 1, wherein said patient-linked HCP comprise at least a first patient-linked HCP with a first patient-linked HCP login information, and a second patient-linked HCP with a second patient-linked HCP login information;
further using said server to receive said machine readable ID code, patient PIN code, and HCP data access privileges from a client computerized device, said HCP data access privileges designating patient permissions to allow said first patient-linked HCP to view either any specific patient-linked HCP entered private data entered by said second patient-linked HCP, to view only specific patient-linked HCP entered private data entered by said second patient-linked HCP, or to view none of the patient-linked HCP entered private data entered by said second patient-linked HCP;
and using said server to transmit patient-linked HCP entered private data entered by said second patient-linked HCP to a patient-linked HCP client computerized device operated by said first patient linked HCP according to said patient permissions.

3. The method of claim 1, further using said server to run client appointment scheduling software, further using said client appointment scheduling software to schedule appointments between said patient and said patient-linked HCP.

4. The method of claim 3, further using said server to automatically notify either said patient, or said patient-linked HCP, of changes in any scheduled appointments by automatically transmitting at least one of either audio telephone messages, emails, SMS messages, social network messages, and fax messages.

5. The method of claim 1, wherein said machine readable ID code comprises an optically encoded 1-dimensional or 2-dimensional bar code, and said token comprises a patient identification card or other patient wearable item;
or wherein said machine readable ID code comprises at least one RFID tag; or wherein said biometric signature comprises a patient fingerprint, facial feature, eye feature, or other body feature.

6. The method of claim 1, wherein said patient public data comprises any of patient name, contact information, patient emergency contact information, and patient healthcare insurance.

7. The method of claim 1, wherein said patient entered private data comprises any of patent profile information, allergies, medications, vaccines, social history, medical history, dental history, surgical history, documents, and health maintenance schedules.

8. The method of claim 1, wherein said patient-linked HCP entered private data comprises HCP notes, HCP entered documents, HCP entered image data, and laboratory reports and data.

9. The method of claim 8, wherein said patient-linked HCP entered private data is electronically imported from a third party electronic medical record system.

10. The method of claim 1, wherein said patient public data comprises patient emergency contact information, wherein said patient emergency contact information has said patient PIN code, and wherein said patient carrying said machine readable ID code on said token is in need of emergency medical services but is unable to provide said patient PIN code;
further using said at least one computer server to obtain at least said patient entered private data by the steps of:
a) using said machine readable ID code and a client computerized device to contact said server and obtain said patient emergency contact information;
b) using said patient emergency contact information to obtain said patient PIN code;
c) using a client computerized device to further provide said patient PIN code to said at least one computer server, thereby designating said client computerized device as a patient authorized computerized device, and transmitting said HCP annotated patient record over said network to said patient authorized computerized device.

11. The method of claim 1, wherein said server is further configured to recognize an emergency medical services identification code, and wherein said server is further configured to transmit at least said partial patient medical record over said network in response to said emergency medical services identification code and patient identification information;
further using said at least one computer server to obtain at least said patient entered private data by providing said emergency medical services identification code and patient identification information to said at least one computer server, thereby designating said client computerized device as an emergency medical services client computerized device, and transmitting at least said partial patient medical record over said network to said emergency medical services client computerized device.

12. The method of claim 1, wherein said server is further configured with a list of HCP, wherein said server transmits at least portions of said list of HCP to said client computerized device;
using said client computerized device to select at least one HCP from said list of HCP, thereby creating at least one selected HCP, and transmitting said selected HCP to said server; and
using at least one of said selected HCP to electronically link said partial patient medical record with at least one HCP, thereby creating at least one patient-linked HCP identified by patient-linked HCP login information.

13. The method of claim 1, wherein said patient-linked HCP entered private data remain initially editable by their entering HCP for a limited time period, and then become permanent and unalterable after said limited time period.

14. A method of operating a unified patient-controlled client-server medical record system configured to manage a plurality of patients and HPC, said method comprising:
For each patient, using at least one computer server to associate a machine readable ID code and patient PIN code to said patient, wherein said machine readable ID code is either encoded on either a token carried by said patient or is carried by a biometric signature associated with said patient, and wherein said patient PIN code is known by said patient, and said machine readable ID code and said patient PIN code are transmitted to said server over a network using a patient authorized client computerized device;
using said machine readable ID code and patient PIN code to receive patient public data and patient entered private data from a client computerized device, thereby creating a partial patient medical record comprising patient public data and patient entered private data, and using said server to store said partial patient medical record in a computer database;
using said server to receive said machine readable ID code, patient PIN code, and at least one link-to-HCP command, and electronically link said partial patient medical record with at least one HCP, thereby creating at least one patient-linked HCP identified by patient-linked HCP login information;
using said server to receive at least one patient-linked HCP entered private data from said patient-linked HCP and store it in said computer database, thus creating for each patent, a HCP annotated patient medical record comprising said partial patient medical record and at least one patient-linked HCP entered private data;
wherein said patient-linked HCP entered private data remain initially editable by their entering HCP for a limited time period, and then become permanent and unalterable after said limited time period;
wherein said patient-linked HCP comprise at least a first patient-linked HCP with a first patient-linked HCP login information, and a second patient-linked HCP with a second patient-linked HCP login information;
further using said server to receive said machine readable ID code, patient PIN code, and HCP data access privileges from a client computerized device, said HCP data access privileges designating patient permissions to allow said first patient-linked HCP to view either any specific patient-linked HCP entered private data entered by said second patient-linked HCP, to view all patient-linked HCP entered private data entered by said second patient-linked HCP, or to view none of the patient-linked HCP entered private data entered by said second patient-linked HCP;
and using said server to transmit patient-linked HCP entered private data entered by said second patient-linked HCP to a patient-linked HCP client computerized device operated by said first patient linked HCP according to said patient permissions;
further using said server to run client appointment scheduling software, further using said client appointment scheduling software to schedule appointments between said patient and said patient-linked HCP;
further using said server to automatically notify either said patient, or said patient-linked HCP, of changes in any scheduled appointments by automatically transmitting at least one of either audio telephone messages, emails, SMS messages, social network messages, and fax messages;
for each patient, retrieving records or data from said database according to any of:
a) using said server to receive only said machine readable ID code from a client computerized device, thereby designating said client computerized device as an unauthorized client computerized device, and transmitting only said patient public data over said network to said unauthorized client computerized device;
a) using said server to receive at least one linked HCP login information from a client computerized device, and thereby designating said client computerized device as a patient-linked HCP client computerized device, and transmitting at least said partial patient medical record to said patient-linked HCP client computerized device;
c) using said server to receive to receive both said machine readable ID code and said patient PIN code from a client computerized device, thereby designating said client computerized device as a patient authorized computerized device, and transmitting said HCP annotated patient record over said network to said patient authorized computerized device.

15. The method of claim 14, wherein said machine readable ID code comprises an optically encoded 1-dimensional or 2-dimensional bar code, and said token comprises a patient identification card or other patient wearable item;
or wherein said machine readable ID code comprises at least one RFID tag; or
wherein said biometric signature comprises a patient fingerprint, facial feature, eye feature, or other body feature.

16. The method of claim 14, wherein said patient public data comprises any of patient name, contact information, patient emergency contact information, and patient healthcare insurance;
wherein said patient entered private data comprises any of patent profile information, allergies, medications, vaccines, social history, medical history, dental history, surgical history, documents, and health maintenance schedules; and
wherein said patient-linked HCP entered private data comprises HCP notes, HCP entered documents, HCP entered image data, and laboratory reports and data.

17. The method of claim 16, wherein said patient-linked HCP entered private data is electronically imported from a third party electronic medical record system.

18. The method of claim 14, wherein said patient public data comprises patient emergency contact information, wherein said patient emergency contact information has said patient PIN code, and wherein said patient carrying said machine readable ID code on said token is in need of emergency medical services but is unable to provide said patient PIN code;
further using said at least one computer server to obtain at least said patient entered private data by the steps of:
a) using said machine readable ID code and a client computerized device to contact said server and obtain said patient emergency contact information;
b) using said patient emergency contact information to obtain said patient PIN code;
c) using a client computerized device to further provide said patient PIN code to said at least one computer server, thereby designating said client computerized device as a patient authorized computerized device, and transmitting said HCP annotated patient record over said network to said patient authorized computerized device.

19. The method of claim 14, wherein said server is further configured to recognize an emergency medical services identification code, and wherein said server is further configured to transmit at least said partial patient medical record over said network in response to said emergency medical services identification code and patient identification information;
further using said at least one computer server to obtain at least said patient entered private data by providing said emergency medical services identification code and patient identification information to said at least one computer server, thereby designating said client computerized device as an emergency medical services client computerized device, and transmitting at least said partial patient medical record over said network to said emergency medical services client computerized device.

20. The method of claim 14, wherein said server is further configured with a list of HCP, wherein said server transmits at least portions of said list of HCP to said client computerized device;
using said client computerized device to select at least one HCP from said list of HCP, thereby creating at least one selected HCP, and transmitting said selected HCP to said server; and
using at least one of said selected HCP to electronically link said partial patient medical record with at least one HCP, thereby creating at least one patient-linked HCP identified by patient-linked HCP login information.
